(19) United States
(12) Patent Application Publication
(10) Pub. No.: US 2012/0246044 A1
(43) Pub. Date: Sep. 27, 2012

(54) Account and Investment Market Monitoring Tools

(75) Inventors: Paul David Fox, Lambertville, NJ (US); Scott Howard Logan, Burlington, NJ (US); Brian Charles Glassman, New York, NY (US); Kristyn S. Harmon, Wellesley, MA (US); Troy Jonathan Miller, Marblehead, MA (US); Peter Tsahalis, Boston, MA (US); David Mieums Ingham, Boston, MA (US); Eugene Cartright, Pelham, NH (US); Abbey Katcher Graf, Morganville, NJ (US); Scott Wilkinson, Bensalem, PA (US); Nancy Shea O'Driscoll, Newton, MA (US); Judith Ann Robichaud, Roslindale, MA (US); Andrew A. Mahoney, Melrose, MA (US); Karen Keeler, South Boston, MA (US); Eric C. Karcher, Boxford, MA (US)

(73) Assignee: BANK OF AMERICA, Charlotte, NC (US)

(21) Appl. No.: 13/168,370

(22) Filed: Jun. 24, 2011

Related U.S. Application Data
(60) Provisional application No. 61/467,952, filed on Mar. 25, 2011.

(51) Int. Cl. G06Q 40/00

(52) U.S. Cl. 705/35

(57) ABSTRACT

Aspects of the present disclosure are directed to a method and system for customers with an account associated with a financial entity to access their accounts and stay on top of one or more financial markets. In accordance with one or more aspects of the present disclosure, customers can review balances, and review holdings. Customers also can stay on top of trades and transactions while still being mobile, e.g., on the go utilizing a handheld computing device. Customers may utilize one or more aspects of the present disclosure to review research reports as well as third-party ratings for potential financial transactions. Customers may receive up-to-the-minute news on one or more financial markets, including real-time quotes, in addition to the ability to see only those research reports, third-party ratings, news on financial markets, and/or particular assets, that the customer has customized.

### STATEMENT OF RELATED APPLICATIONS

This application is a non-provisional application of and claims the benefit of priority from U.S. provisional application Ser. No. 61/467,952, entitled “Account and Investment Market Monitoring Tools,” filed Mar. 25, 2011, which is incorporated herein by reference in its entirety.

### BACKGROUND

There is always a need for a financial entity to retain its customers business and to create more products and/or services to acquire more customers. Such as desire is no different in the mobile environment. Today, customers can access their account information on a handheld computing device, such as a smartphone. Yet, such access is limited to the configurations of the application program offered by the financial entity of the customer. The layout and orientation of the data presented to the customer is configured by the application program. A customer may be forces to drill down several layers to acquire data critical for review and/or analysis.

Still further, in order to acquire much needed input form a financial adviser, a customer is left with no option but to contact her financial advisor completely separate from the application program. Such a transition may force a customer to exit out of the application program in order to launch a new application program. As such, a customer cannot interact directly with her financial advisor while still reviewing and/or analyzing her assets associated with the financial entity in the application program.

### SUMMARY

In light of the foregoing background, the following presents a simplified summary of the present disclosure in order to provide a basic understanding of some aspects of the present disclosure. This summary is not an extensive overview of the present disclosure. It is not intended to identify key or critical elements of the present disclosure or to delineate the scope of the present disclosure. The following summary merely presents some concepts of the present disclosure in a simplified form as a prelude to the more detailed description provided below.

Aspects of the present disclosure are directed to a method and system for customers with an account associated with a financial entity and/or a wealth management entity to access their accounts and stay on top of one or more financial markets. In accordance with one or more aspects of the present disclosure, customers can review balances, review holdings, and review pending transactions. Customers can also stay on top of trades and transactions while still being mobile, e.g., on the go utilizing a handheld computing device. Customers may utilize one or more aspects of the present disclosure to review research reports as well as third-party ratings for potential financial transactions. Customers may receive up-to-the-minute news on one or more financial markets, including real-time quotes, in addition to the ability to see only those research reports, third-party ratings, news on financial markets, and/or particular assets, that the customer has customized to see.

In accordance with another aspect of the present disclosure, customers may check on the status of any orders, may set up alerts to stay on top of their accounts on individual assets, and may manage and monitor watch lists for one or more assets. Still further, customers may view investment accounts as well as other financial accounts associated with a financial entity implementing one or more aspects of the present disclosure in a single user interface on a handheld computing device. Customers may also transfer money between different investment accounts and other financial accounts associated with the financial entity, such as a checking account and/or a savings account.

Aspects of the present disclosure may be provided in a non-transitory computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of handheld computing devices and servers that may be used to implement the processes and functions of certain embodiments of the present disclosure;

FIG. 3 is an example user interface for individual customization of a financial entity application operating on a handheld computing device in accordance with at least one aspect of the present disclosure;

FIG. 4 is another example user interface for individual customization of a financial entity application operating on a handheld computing device in accordance with at least one aspect of the present disclosure;

FIG. 5 is an example user interface for conducting a communication session with a handheld computing device in accordance with at least one aspect of the present disclosure;

FIG. 6 shows a flow chart of an illustrative method for individual customization of a financial entity application operating on a handheld computing device in accordance with at least one aspect of the present disclosure; and

FIG. 7 shows a flow chart of an illustrative method for conducting a communication session with a handheld computing device in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

Various aspects described herein may be embodied as a method, a data processing system, and/or a computer program product. Accordingly, those aspects may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of tangible and/or non-transitory computer readable storage media such as hard disks, CD-ROMs, optical storage devices, magnetic storage devices, and/or any combination thereof.

Aspects of the method steps disclosed herein may be executed on one or more processors on a handheld computing device 101. Such processors may execute computer-executable instructions stored on non-transitory computer-readable media. The disclosure may also be practiced in distributed computing environments where tasks are performed by remote processing devices that are linked through a communications network. In a distributed computing environment, program modules may be located in both local and remote computer storage media including memory storage devices.

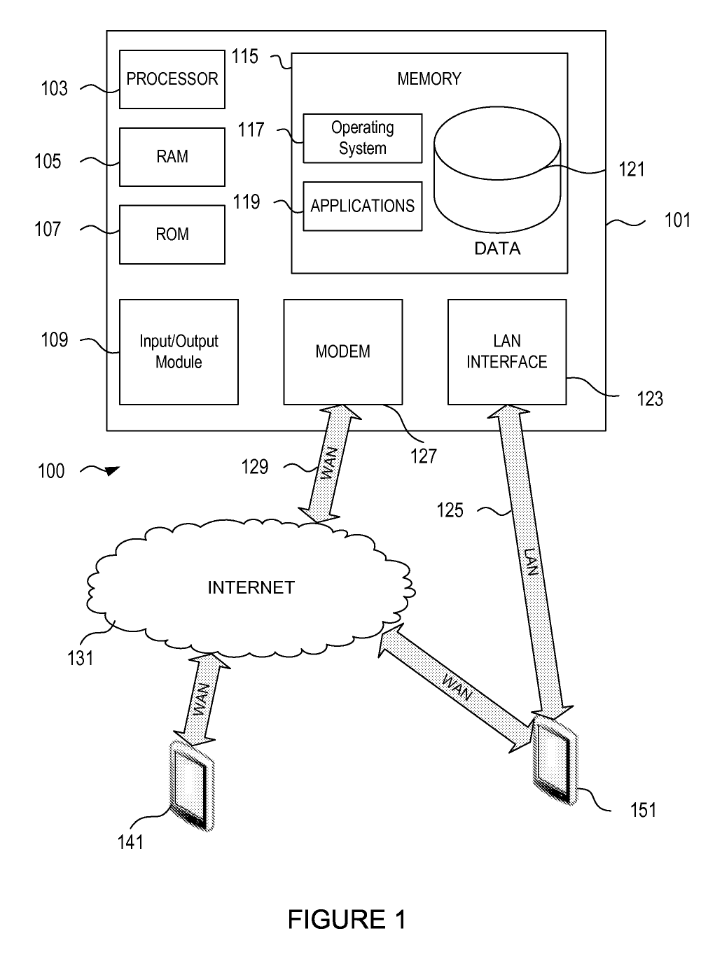

FIG. 1 illustrates a block diagram of a generic handheld computing device 101 (e.g., a handheld computing device, such as an iPad by Apple® Corporation) that may be used according to an illustrative embodiment of the disclosure. The computing device 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of computing device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of handheld computing device 101 computer executable instructions may be embodied in hardware or firmware (not shown). As described in detail below, the database 121 may provide centralized storage of characteristics associated with individuals, allowing interoperability between different elements of the business residing at different physical locations.

The computing device 101 may operate in a networked environment supporting connections to one or more remote computers, such as terminals 141 and 151. The terminals 141 and 151 may be other handheld computing devices that include many or all of the elements described above relative to the computing device 101. The network connections depicted in FIG. 127 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

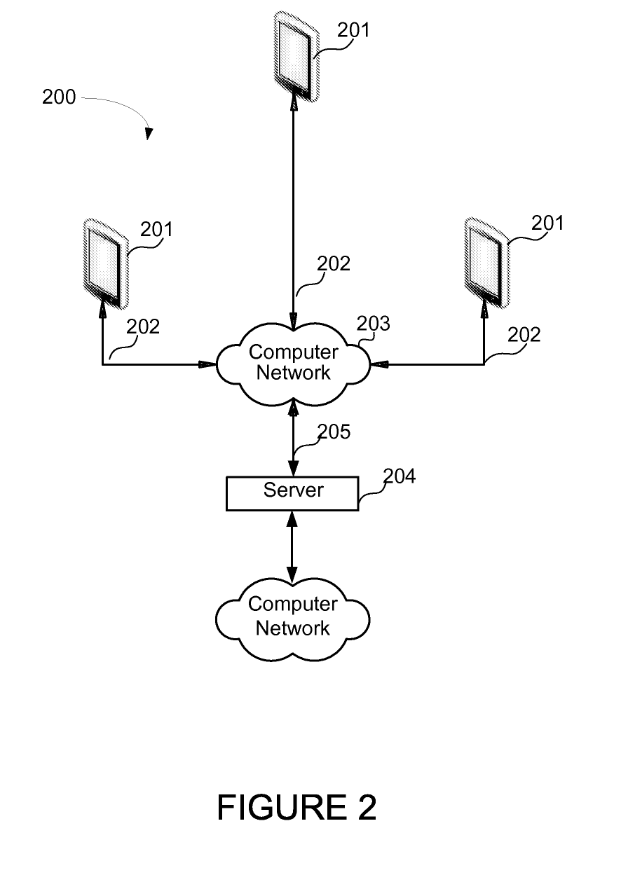

Referring to FIG. 2, an illustrative system 200 for implementing methods according to the present disclosure is shown. As illustrated, system 200 may include one or more handheld computing devices 201. Handheld computing devices 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between handheld computing devices 201 and server 204, such as network links, dial-up links, wireless links, hard-wired links, etc.

The steps and features that are described herein may be implemented by one or more of the components in FIGS. 1 and 2 and/or other components, including other computing devices.

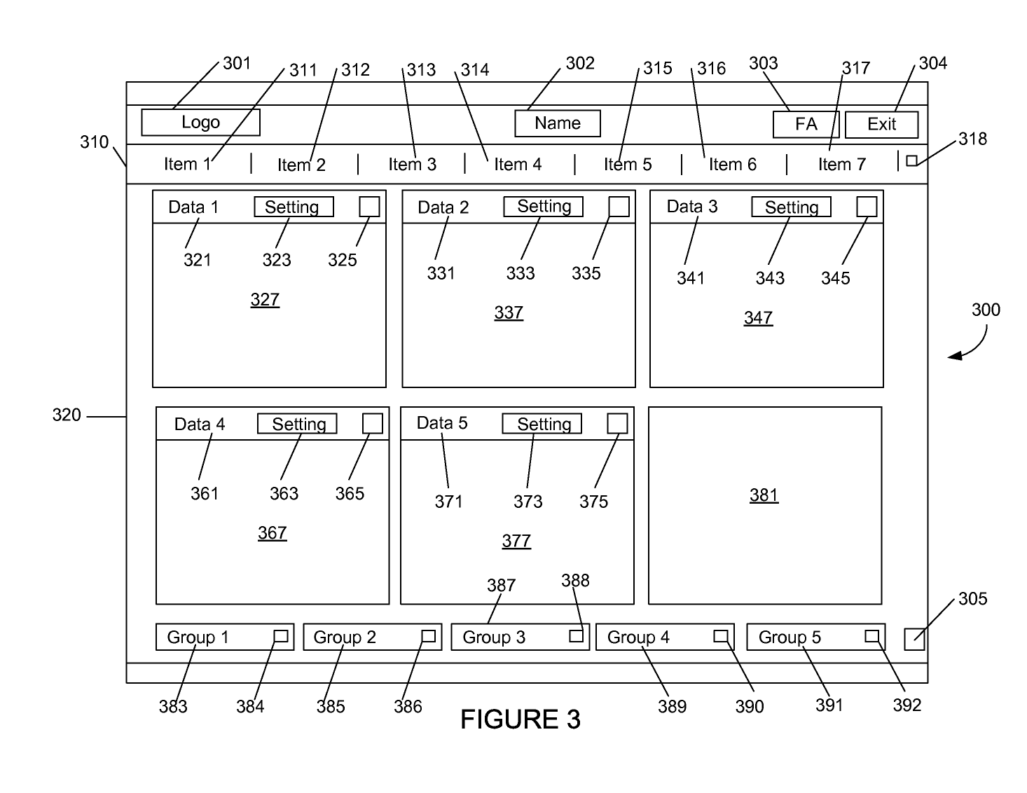

FIG. 3 is an example user interface 300 for individual customization of a financial entity application operating on a handheld computing device in accordance with at least one aspect of the present disclosure. User interface 300 allows an individual to customize the home screen 320 and/or other screens for a financial entity application running on the handheld computing device. The financial entity application may be configured to allow the individual to see one or more aspects of current investment assets, market news, particular market assets of interest, account summary data, transactional data, and/or other data. User interface 300 may include a logo 301 associated with the financial entity application. Logo 301 may include an underlying link to a website associated with the financial entity, thus allowing the individual quickly to access other information about the financial entity. Field 302 may include the name of the individual. Thus an individual can confirm they are at the proper user interface and not one for another family member, such as a spouse. Field 303 may allow an individual to initiate a communication session with a financial advisor of the individual as described in more detail herein. Field 304 may be an access button to allow the individual to exit the financial entity application all together. Alternatively, field 304, when first clicked on for access, may include a drop down box for allowing the individual to choose form a number of options, such as changing to a different individual associated with the financial entity application or exiting.

User interface 300 further may include one or more groups of types of information for display purposes. These groups may correlate to one or more different screens that the individual may access and/or configure. In user interface 300, five illustrative groups are shown as Group 1 383, Group 2 385, Group 3 387, Group 4 389, and Group 5 391. In one illustrative example, Group 1 383 may be the home screen that initially comes up when an individual initiates the financial entity application on the handheld computing device. For example, Group 1 383 may be a screen for portfolio review of the individual. Thus, windows 327, 337, 347, 367, and 377 may all be windows configured with respect to assets of the individual in a portfolio associated with the financial entity. Group 2 385 may be a screen for research and insight news, Group 3 387 may be a screen for market and other news, group 4 389 may be a screen for financial planning, and Group 5 391 may be a screen for monetary transfers and paying bills out of an account of the individual. Any of a number of different groups may be configured for any of a number of different purposes as desired by the individual in customizing the screens. The individual can switch between screen by accessing one or more of the access buttons 384, 386, 388, 390, and 393, associated with the respective Groups 1, 2, 3, 4, and 5. Fewer or more groups may be included. In this example of FIG. 3, configuration button 305, if accessed by an individual, allows the individual to add, delete, and/or modify the order of and/or data within the groups. One or more additional pop-up windows, drop-down boxes, and/or other input mechanisms may be utilized to allow for such customization.

The home screen 320 of the user interface 300 for the financial entity application running on the handheld computing device may allow for the individual to customize the orientation of one or more windows that include specific types of data as described herein. For example, an individual may configure a window for display of all accounts of the individual associated with the financial entity. In user interface 300, window 327 may show such data regarding the accounts of the individual. The individual may configure a second window for display of all market news associated with her current investment assets. In user interface 300, window 337 may show such data regarding market news associated with her current investment assets. The individual may configure a third window for display of all market news associated with other investment assets the customer may want to watch, e.g., see how the investment asset is reacting to market trends. In user interface 300, window 347 may show such data regarding market news associated with other investment assets the customer may want to watch.

In one example, FIG. 3 may be an illustrative user interface 300 the individual may see upon initially accessing the financial entity application. In deciding to customize the home screen 320, the customer may enter an edit mode for editing one or more windows, e.g., windows 327, 337, 347, 367, and/or 377, of the home screen 320. Any of a number of manners for editing window types and/or data may be implemented herein. Illustrative examples include pop-up windows, drop-down boxes, selection fields, text boxes, and/or other input mechanisms may be utilized to allow for such customization. In FIG. 3, five windows are shown, windows 327, 337, 347, 367, and 377. A window identifier may be included for one or more windows. Window identifiers 321, 331, 341, 361, and 371 identify respective windows 327, 337, 347, 367, and 377. Illustrative window identifiers include “Accounts,” “Holdings,” Account Updates,” “Market News,” “Market Summary,” “Sector performance,” “Watchlists,” and “Commodities.” However, as should be understood, any one or more window identifiers may be customized in name as well by an individual.

Settings fields 323, 333, 343, 363, and 373 may be drop-down menus of options for an individual associated with a particular window type. For example, for a window for accounts of the individual, the settings field may allow the individual to switch the data in the window between “All Accounts,” “Checking Accounts,” “Money market Accounts,” “Retirement Accounts,” and/or “Mortgage Accounts.” Any of a number of other options may be included. Settings fields 323, 333, 343, 363, and 373 allow the individual to switch between different settings for the respective window quickly. With respect to any window of the windows displayed on a home screen, such as windows 327, 337, 347, 367, and/or 377 in home screen 320 of FIG. 3, an individual may access a single window for expansion of the window to provide more details associated with that particular window. In this example of FIG. 3, expansion buttons 325, 335, 345, 365, and 375, allow for expansion of windows 327, 337, 347, 367, and 377, respectively.

In the example of FIG. 3, only five windows are shown in home screen 320. An individual may add, delete, and/or modify a window at any time. In one example, by accessing field 381, an individual may be allowed to add a window to home screen 320. In another example, the individual may be able to delete and window and/or modify the window, such as changing the location of the window within the home screen 320. One or more pop-up windows, drop-down boxes, and/or other input mechanisms may be utilized to allow for such customization.

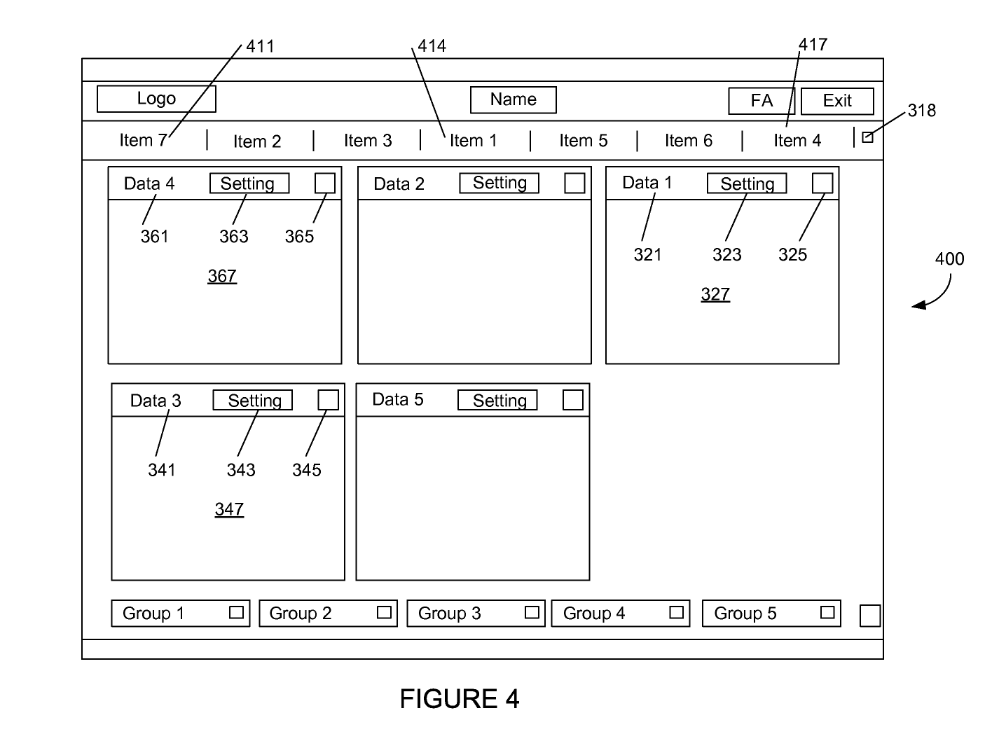

Moving to the example of FIG. 4, user interface 400 may be an example of the user interface after an individual has moved the locations of certain windows in FIG. 3. In the example of FIG. 4, windows 327, 347, and 367 have been modified from their original positions in FIG. 3 to their individual-defined positions in FIG. 4. As should be understood, the modification of windows from FIG. 3 to FIG. 4 is but one example modification that may be implemented in accordance with the description herein and that any of a number of other modifications, additions, and/or deletions may be implemented.

The illustrative windows 327, 337, 347, 367, and 377 shown in FIG. 3 illustrate various manners for allowing a individual to view her assets, create and manage watch lists for assets, transfer monies from individual accounts to one or more investment accounts, create and manage customized ticker banners, create and manage customized financial market news, create and manage customized financial research news associated with one or more investment assets, whether current and/or potential, and initiate and have a communication session with a financial advisor of the individual.

In addition, an individual may configure a ticker 310 for display of market data, such as gain/loss, current price, etc. for investment assets and may limit the investment assets to only those the individual has a financial interest in, only those the individual has an interest in watching, and/or other customized configurations. In FIG. 3, seven investment assets may be shown. These examples are Item 1 311, Item 2, 312, Item 3 313, item 4 314, item 5 315, Item 6 316, and Item 7 317. Fewer or more investment assets may be included within ticker 310. In addition, ticker 310 may be configured to scroll the investment assets across the user interface. In this example of FIG. 3, configuration button 318, if accessed by an individual, allows the individual to add, delete, and/or modify the order of investment assets shown in the ticker 310. One or more additional pop-up windows, drop-down boxes, and/or other input mechanisms may be utilized to allow for such customization.

FIG. 4 illustrates an example user interface 400 in which an individual has modified the configuration of the investment assets in the ticker. Item 7 is now in an individual defined first position in the ticker 310 as identified by reference 411. Similarly, Items 1 and 4 are now in individual defined fourth and seventh positions, respectively, in the ticker 310 in FIG. 4 as identified by references 414 and 417, respectively. As such, an individual is permitted to include any investment assets desired to be included by the individual.

Still further, if the individual is not certain of the investment assets she has, one option may be for the individual to choose “Include Investment Assets in My Portfolio.” Thus, the individual can customize the ticker 310 to include only those investment assets that the individual has in her portfolio and she need not have to recall each and every one individually to include. The system may look to the investment assets in her portfolio and automatically configure the ticker 310 for those investment assets.

Illustrative user interface 300 allows an individual to customize the ticker 310 to be located, in this case, near the top of a display screen of the handheld computing device. In accordance with one or more aspects of the present disclosure, an individual may configure the location of the ticker 310 in any of a number of different individual defined locations.

Aspects of the present disclosure further provide a mechanism for collaboration between an individual and a financial advisor while the individual is utilizing a financial entity application on a handheld computing device. In reviewing one or more financial assets and/or financial investments of the individual through the financial entity application on the handheld computing device, the individual may initiate a communication session with her financial advisor. The communication session may be by Short Message Service (SMS) communication, and Multimedia Messaging Service (MMS) communication, and e-mail exchange, and/or some other form of direct communication. Implementation of communication between the individual and her financial advisor is through the financial entity application, operating on the handheld computing device, implementing one or more of the aspects described herein. As such, an individual may utilize her handheld computing device to review her current investment assets, review current market news associated with her current investment assets, and immediately communicate with her financial advisor for any questions about and/or changes to her current investment assets she may have.

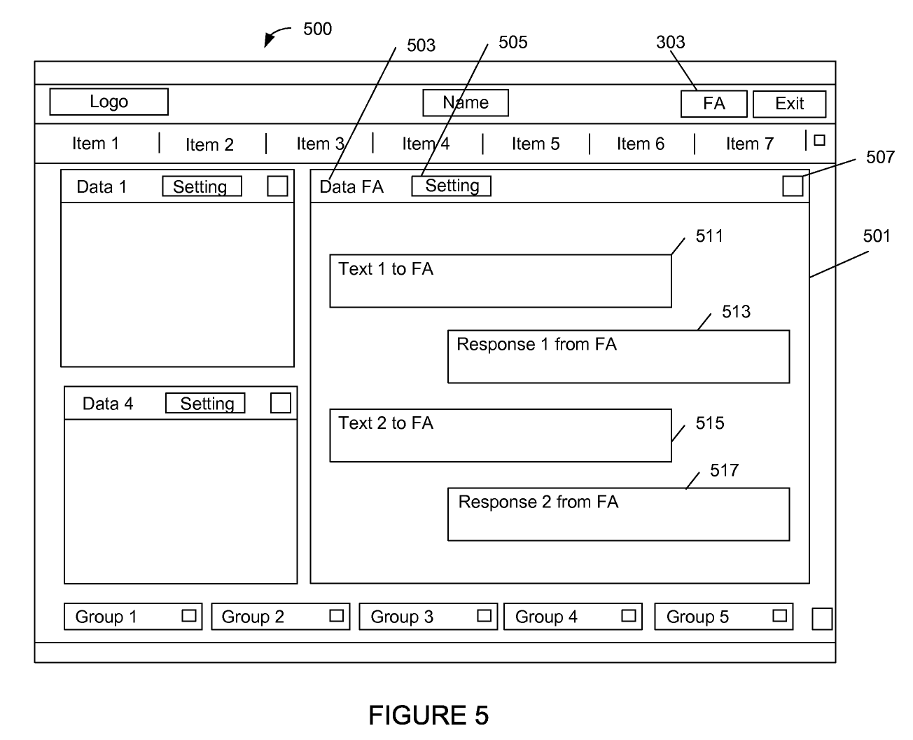

FIG. 5 is an example user interface 500 for conducting a communication session with a handheld computing device in accordance with at least one aspect of the present disclosure. User interface 500 allows an individual to initiate and conduct a communication session with a financial advisor through a financial entity application running on the handheld computing device. The financial entity application may be configured to allow the individual send and receive SMS, MMS, and/or e-mail communications. User interface 500 may be rendered upon an individual accessing filed 303 as described with respect to FIG. 3. In accessing field 303, window 501 may be opened as part of the process for initiating a communication session.

A window identifier 503 may be included window 501. The window identifier may identify the communication session in some way, such as the name of the financial advisor. A setting field 505 may be included with window 501. Setting field 505 may allow for the individual to select the manner of communication. For example, accessing field 505 may launch a drop-down box of options for communication, including SMS, MMS, and e-mail. By accessing setting filed 505, an individual may set the type of communication for the communication session with the financial advisor. Field 507 may be an access button to allow the individual to exit the communication session all together.

Within window 501, the individual may transmit and receive communications with a financial advisor. In the example of FIG. 5, an individual may enter a first communication 511 to the financial advisor, e.g., a textual communication about an investment asset of the individual. The application may coordinate with the handheld computing device to transmit the communication to the financial advisor. The individual may receive a first communication 513 from the financial advisor, e.g., a textual communication response about the investment asset of the individual. In response, a dialog may continue between the individual sending additional communications 515 to the financial advisor while receiving additional communication responses 517 from the financial advisor. All correspondence transmitted to the financial advisor and received from the financial advisor are through the financial entity application operating on the handheld computing device.

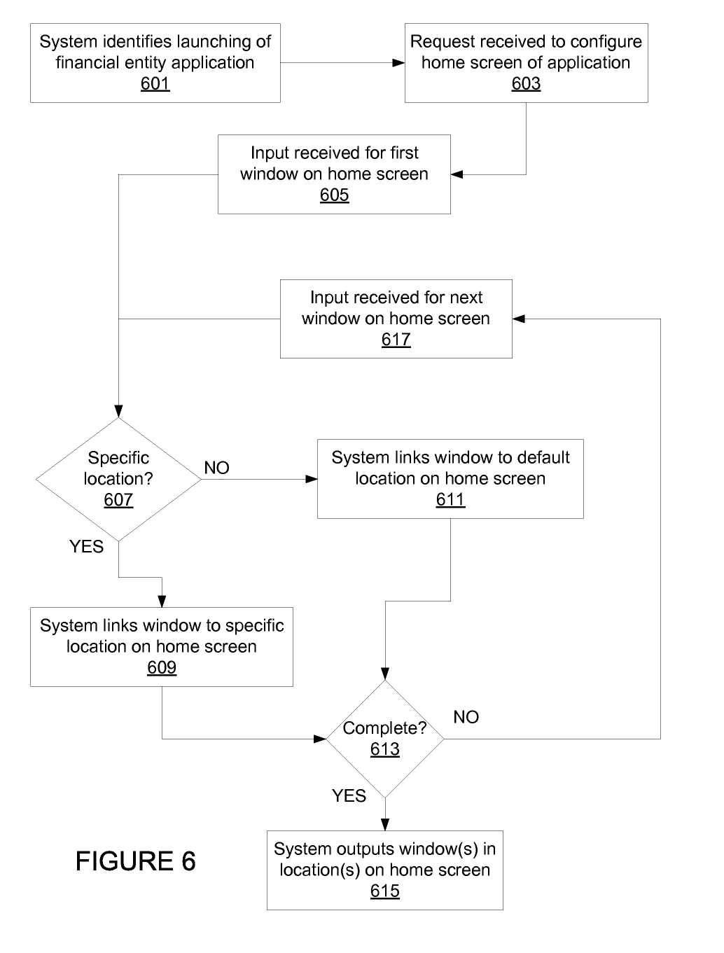

FIG. 6 shows a flow chart of an illustrative method for individual customization of a financial entity application operating on a handheld computing device in accordance with at least one aspect of the present disclosure. The process starts and at 601 a system identifies the launching of a financial entity application on a handheld computing device as described herein. Identification of the launching of the application may be in response to receiving an individual input on the handheld computing device to open the application. The financial entity application may be represented on a display of the handheld computing device as an icon and/or logo identifying the application. In one example, in response to receiving the request to access the application, user interface 300 of FIG. 3 may be displayed on the display of the handheld computing device.

Proceeding to 603, a request may be received to configure the home screen of the financial entity application. In a situation of a first user by the individual, the home screen may be some type of default screen with no windows included at all and/or some default orientation of windows, groups, ticker, etc. The request may be an input by the individual to customize the home screen of the application, such as by entering an edit mode for configuration of the home screen. In 605, an input may be received for creation of a first window in the home screen. In such an example, the individual may input data to request the creation of a window to show market news with respect to investment assets she has in her portfolio.

Proceeding to 607, a determination may be made as to whether the request in 605 included data representative of specification of a specific location, by the individual, of the first window in the home screen. For example, the individual may want the new first window to be placed in the upper left area, such as window 327 in FIG. 3. If an individually-defined specific location was determined in 607, the process moves to 609 where the system links the window to the specific individually-defined location on the home screen. The window may include any of a number of data including a summary of one or more accounts of the individual associated with the financial entity, such as a checking account, retirement account, money market account, 401K account, a listing of one or more holdings of the individual with the financial entity, and/or one or more market news listings for the one or more holdings of the individual associated with the financial entity.

If no specific location was determined in 607, the process may move to 611 where the system links the window to a default location on the home screen. Such a default location may be an open/unused location for insertion of a window, such as location 381 in FIG. 3. Proceeding to 613, a determination may be made as to whether the editing process is complete. For example, the system may receive an input by the individual to exit the edit mode for customizing the home screen. As such, the system may determine, in 613, that the customization is complete and proceed to 615 where the system may output the customized windows as the default and/or individually-defined specific locations on the home screen. Alternatively, if the editing process is not complete in 613, the process may proceed to 617 where another input may be received for creation of a next window in the home screen. From 617, the process proceeds back to 607. As such, the process may continue for customization of any of a number of different windows until complete and the process moves to 615.

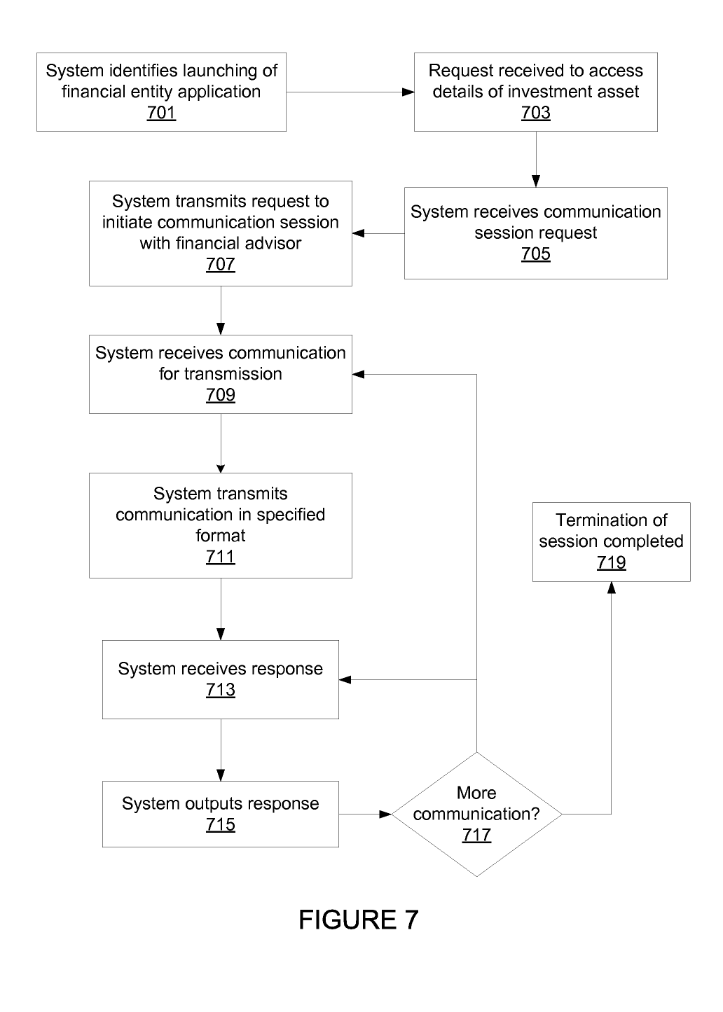

FIG. 7 shows a flow chart of an illustrative method for conducting a communication session with a handheld computing device in accordance with at least one aspect of the present disclosure. The process starts and at 701 a system identifies the launching of a financial entity application on a handheld computing device as described herein. Identification of the launching of the application may be in response to receiving an individual input on the handheld computing device to open the application. The financial entity application may be represented on a display of the handheld computing device as an icon and/or logo identifying the application. In one example, in response to receiving the request to access the application, user interface 300 of FIG. 3 may be displayed on the display of the handheld computing device.

Proceeding to 703, a request may be received to access details of one or more investment assets of the individual. For example, the individual may request to see details of a stock in her portfolio and its performance over a period of time, such as the last 3 months. In one example, the individual may be considering the sale of the stock and would like to be able to talk with her financial advisor about it. Proceeding to 705, a system may receive a request form the individual to initiate a communication session with her financial advisor. Such a request to initiate a communication session may be accessing of field 303 in FIG. 3. As part of the request to initiate the communication session, the system automatically may determine and/or may receive an individual input of the type of communication manner to utilize, e.g., SMS, MMS, or e-mail.

In 707, the system may transmit, to a system associated with the financial advisor, a request initiate the communication session with the financial advisor. The request may be an initial data request to confirm availability and/or an open communication channel. Moving to 709, the system may receive an individually entered communication for transmission. The communication in 709 may be a communication about the one or more investment assets that the individual wants to discuss, e.g., a question to the financial advisor as to whether the stock in question is likely to bounce back up to a higher price soon. The receipt of the individually entered communication may be through the financial entity application.

In 711, the system may transmit, to the system associated with the financial advisor, the communication from 709 in a specified format, such as SMS, MMS, or e-mail. Proceeding to 713, the system may receive a financial advisor entered response. The response in 713 may be a communication from the financial advisor responsive to the communication in 709. The receipt of the response may be through the financial entity application. In 715, the system may out the response form the financial advisor to a display of a handheld computing device. The process then may proceed to 717 where a determination may be made as to whether there are more communications to be transmitted and/or received. If there are no communications the process may move to 719 where termination of the session is completed. For example, the system may receive an exit input form the individual as part of the determination in 717. Such an exit input may be the individual accessing the filed 507 in FIG. 5. If there are more communications to be transmitted and/or received, the process may return back to 709 and/or 713 accordingly.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments.

What is claimed is:

1. A handheld computing apparatus comprising:
a display;
at least one processor; and
at least one memory having stored therein computer executable instructions, that when executed by the at least one processor, cause the handheld computing apparatus to perform a method of:
identifying access to a financial monitoring application of a financial entity operating on the handheld computing apparatus;
receiving a request from an individual to configure a home screen of the application;
receiving a first input from the individual representative of creation of a first window and representative of specification of an individual-defined location of the first window for display in an individual-defined first location on the home screen of the application, the first window including a summary of at least one account of the individual associated with the financial entity;
receiving a second input from the individual representative of creation of a second window and representative of specification of an individual-defined location of the second window for display in an individual-defined second location on the home screen of the application, the second window including a listing of at least one holding of the individual associated with the financial entity;
receiving a third input from the individual representative of creation of a third window and representative of specification of an individual-defined location of the third window for display in a user-defined third location on the home screen of the application, the third window including a listing of market news for the at least one holding of the individual associated with the financial entity; and
outputting, to the display, the first window in the individual-defined first location, the second window in the individual-defined second location, and the third window in the individual-defined third location on the home screen of the application.

2. The handheld computing apparatus of claim 1, the computer executable instructions further causing the apparatus to perform a method of receiving a fourth input from the individual representative of creation of a ticker and representative of specification of an individual-defined location of the ticker for display in an individual-defined fourth location on the home screen of the application, the ticker including a listing of individual-defined investment assets.

3. The handheld computing apparatus of claim 2, wherein the individual-defined investment assets are holdings of the individual.

4. The handheld computing apparatus of claim 1, wherein the listing of market news for the at least one holding of the individual associated with the financial entity is an individual-defined listing of market news.

5. The handheld computing apparatus of claim 1, wherein the listing of market news for the at least one holding of the individual associated with the financial entity is an individual-defined listing of research reports.

6. A handheld computing apparatus comprising:
a display;
at least one processor; and
at least one memory having stored therein computer executable instructions, that when executed by the at least one processor, cause the handheld computing apparatus to perform a method of:
identifying access to an application of a financial entity operating on the handheld computing apparatus;
receiving a request from an individual to access details of at least one investment asset of the individual through the application, the investment asset associated with the financial entity;
receiving a first input from the individual representative of initiation of a communication session between the individual and a financial advisor of the individual through the application;
receiving a second input from the individual representative of a communication from the individual to the financial advisor about the at least one investment asset through the application;
receiving a third input from the financial advisor representative of a response from the financial advisor to the individual about the at least one investment asset through the application; and
outputting, to the display, the response from the financial advisor to the individual about the at least one investment asset.

7. The handheld computing apparatus of claim 6, wherein the at least one investment asset is at least one of: an account of the individual with the financial entity and a holding of the individual with the financial entity.

8. The handheld computing apparatus of claim 6, wherein the communication session is one of: a Short Message Service (SMS) communication, a Multimedia Messaging Service (MMS) communication, and an electronic mail (e-mail) communication.

9. The handheld computing apparatus of claim 6, the computer executable instructions further causing the apparatus to perform a method of responsive to receiving the first input from the individual representative of initiation of the communication session between the individual and the financial advisor of the individual through the application transmitting a request to initiate the communication session with the financial advisor.

10. The handheld computing apparatus of claim 6, wherein the outputting is through the application.

11. One or more non-transitory computer-readable media storing computer-readable instructions that, when executed by at least one handheld computing apparatus, cause the at least one handheld computing apparatus to perform a method of:
identifying access to a financial monitoring application of a financial entity operating on the handheld computing apparatus;
receiving a request from an individual to configure a home screen of the application;
receiving a first input from the individual representative of creation of a first window and representative of specification of an individual-defined location of the first window for display in an individual-defined first location on the home screen of the application, the first window including a summary of at least one account of the individual associated with the financial entity;
receiving a second input from the individual representative of creation of a second window and representative of specification of an individual-defined location of the second window for display in an individual-defined second location on the home screen of the application, the second window including a listing of at least one holding of the individual associated with the financial entity;
receiving a third input from the individual representative of creation of a third window and representative of specification of an individual-defined location of the third window for display in a user-defined third location on the home screen of the application, the third window including a listing of market news for the at least one holding of the individual associated with the financial entity; and
outputting the first window in the individual-defined first location, the second window in the individual-defined second location, and the third window in the individual-defined third location on the home screen of the application.

12. The one or more non-transitory computer-readable media of claim 11, the computer readable instructions further causing the at least one handheld computing apparatus to perform a method of receiving a fourth input from the individual representative of creation of a ticker and representative of specification of an individual-defined location of the ticker for display in an individual-defined fourth location on the home screen of the application, the ticker including a listing of individual-defined investment assets.

13. The one or more non-transitory computer-readable media of claim 12, wherein the individual-defined investment assets are holdings of the individual.

14. The one or more non-transitory computer-readable media of claim 11, wherein the listing of market news for the at least one holding of the individual associated with the financial entity is an individual-defined listing of market news.

15. The one or more non-transitory computer-readable media of claim 11, wherein the listing of market news for the at least one holding of the individual associated with the financial entity is an individual-defined listing of research reports.

16. One or more non-transitory computer-readable media storing computer-readable instructions that, when executed by a handheld computing apparatus, cause the handheld computing apparatus to perform a method of:
identifying access to an application of a financial entity operating on the handheld computing apparatus;
receiving a request from an individual to access details of at least one investment asset of the individual through the application, the investment asset associated with the financial entity;
receiving a first input from the individual representative of initiation of a communication session between the individual and a financial advisor of the individual through the application; receiving a second input from the individual representative of a communication from the individual to the financial advisor about the at least one investment asset through the application; receiving a third input from the financial advisor representative of a response from the financial advisor to the individual about the at least one investment asset through the application; and outputting, to the display, the response from the financial advisor to the individual about the at least one investment asset.

17. The one or more non-transitory computer-readable media of claim 16, wherein the at least one investment asset is at least one of: an account of the individual with the financial entity and a holding of the individual with the financial entity.

18. The one or more non-transitory computer-readable media of claim 16, wherein the communication session is one of: a Short Message Service (SMS) communication, a Multimedia Messaging Service (MMS) communication, and an electronic mail (e-mail) communication.

19. The one or more non-transitory computer-readable media of claim 16, the computer-readable instructions further causing the handheld computing apparatus to perform a method of responsive to receiving the first input from the individual representative of initiation of the communication session between the individual and the financial advisor of the individual through the application transmitting a request to initiate the communication session with the financial advisor.

20. The one or more non-transitory computer-readable media of claim 16, wherein the outputting is through the application.
